(19) United States
(12) Patent Application Publication
(10) Pub. No.: US 2026/0045576 A1
(43) Pub. Date: Feb. 12, 2026

(54) DUAL COOLING SOURCE DIRECT EXPANSION LIQUID COOLING SYSTEM FOR BATTERY ENERGY STORAGE AND ITS CONTROL METHOD

(71) Applicant: Changsha University of Science & Technology, Changsha (CN)

(72) Inventors: Xiaoqin SUN, Changsha (CN); Yuehao Chen, Changsha (CN); Ao Peng, Changsha (CN); Huahua Zhou, Changsha (CN); Junze Zeng, Changsha (CN); Shuguang Liao, Changsha (CN)

(21) Appl. No.: 19/289,397

(22) Filed: Aug. 4, 2025

(30) Foreign Application Priority Data
Aug. 7, 2024 (CN) 202411080275.0

(51) Int. Cl. H01M 10/635; B60H 1/00; H01M 10/613; H01M 10/6554; H01M 10/6556; H01M 10/6564; H01M 10/6568; H01M 10/659; H01M 10/663

(52) U.S. Cl. CPC H01M 10/635; B60H 1/00278; B60H 1/00328; B60H 1/00485; H01M 10/613; H01M 10/6554; H01M 10/6556; H01M 10/6564; H01M 10/6568; H01M 10/659; H01M 10/663

(57) ABSTRACT

A dual cooling source direct expansion liquid cooling system for battery energy storage and a control method. The system includes an air conditioning and refrigeration system, a battery management system and a control system; the battery management system includes a plurality of battery packs and a cold plate provided in correspondence with the battery packs; the battery pack is in direct contact with the cold plate for heat exchange; the cold plate is provided with a heat exchanger tube running through the cold plate and a phase change thermostatic material; the phase change thermostatic material is used to absorb heat from the battery pack and change the liquid refrigerant phase into gaseous refrigerant entering the heat exchanger tube; the heat exchanger tube output end of the cold plate is connected to the air conditioning and refrigeration system via an intermediate system.

### CROSS-REFERENCE TO RELATED APPLICATION

This application claims priority from the Chinese patent application 202411080275.0 filed Aug. 7, 2024, the content of which is incorporated herein in the entirety by reference.

### TECHNICAL FIELD

The present disclosure relates to a dual cooling source direct-expansion liquid cooling system for battery energy storage and a control method thereof.

### BACKGROUND

With the rapid growth in areas such as electric vehicles, renewable energy storage and portable devices, the importance of battery thermal management becomes more significant. Batteries generate heat in the process of charging and discharging, and high temperature environment and poor battery temperature uniformity have a negative impact on the efficiency of the battery, resulting in loss of capacity, power reduction and shortened cycle life. Under the dual-carbon strategy and energy transition, with the blowout development of grid-connected renewable energy power generation, high efficient and reliable battery thermal management technology will certainly become the key support for the construction of a new type of power system and the realization of the national energy transition strategy.

At present, the solution to the high working temperature and the temperature difference of the battery is mainly air-cooled cooling and cold plate liquid cooling technology. On the one hand, air-cooled cooling is a low cooling efficiency, energy consumption, can not meet the heat dissipation needs of high-density energy storage system. On the other hand, cold plate liquid cooling technology has the problems of complex structure and poor temperature uniformity, which seriously threaten the safe operation of the battery. Therefore, it is necessary to carry out technical innovation for the battery temperature control problem. Reducing the energy consumption of the cooling system, reducing the battery operating temperature, the battery temperature difference are urgent problems to be solved nowadays.

### SUMMARY

The purpose of the present disclosure is to overcome the above deficiencies of the prior art and provide a dual cold source direct expansion liquid cooling system for battery energy storage and its control method, with the aim of reducing system energy consumption, reducing battery operation temperature and battery temperature difference, and ensuring safe and stable operation of the battery.

The technical solution of the present disclosure is:

An aspect of the present disclosure is summarized as A dual cooling source direct expansion liquid cooling system for battery energy storage comprising:
Air conditioning and refrigeration systems. It includes an air-cooling system and a liquid-cooling system; the air-cooling system and the liquid-cooling system are switched and controlled by a first three-way valve and a second three-way valve;
Battery management system. It includes a plurality of battery packs and a cold plate setted opposite to the battery packs; the battery packs are in direct contact with the cold plate for heat exchange; the cold plate is provided with a heat exchanger tube and phase change thermostatic material through the cold plate; the phase change thermostatic material is used to absorb the heat from the battery packs, and the liquid refrigerant that enters the heat exchanger tube is changed into a gaseous refrigerant; the output end of the heat exchanger tube of the cold plate is connected to the air conditioning and refrigeration system through the intermediary system;
Control system. used for controlling the first three-way valve and the second three-way valve to switch to an air-cooling system when the outdoor temperature is detected to be not greater than the set temperature, and for controlling the first three-way valve and the second three-way valve to switch to a liquid-cooling system when the outdoor temperature is detected to be greater than the set temperature; further for controlling the constant temperature water tank of the liquid cooling system to adjust the temperature to the first target temperature when the outdoor temperature is detected to be greater than the set temperature while the temperature of the gaseous refrigerant output from the cold plate is not greater than the set temperature of the gaseous refrigerant; and controlling the thermostatic water tank of the liquid cooling system to thermoregulate to the second target temperature when the outdoor temperature is detected to be greater than the set temperature while the temperature of the gaseous refrigerant output from the cold plate is greater than the set temperature of the gaseous refrigerant, and the second target temperature is lower than the first target temperature.

Further, a plurality of battery packs are provided in parallel with each other, and each battery pack is provided with a cold plate at the bottom, and the inlet side of the heat exchanger tube of each cold plate is connected in series with the first control valve; the inlet side of each first control valve is jointly connected to the liquid outlet of a liquid storage tank through a pipeline, and the liquid inlet of the liquid storage tank is connected to the air conditioning and refrigeration system; and the outlet side of the heat exchanger tube of each cold plate is jointly connected to the intermediate system through a pipeline; the output end of the intermediate system is selectively connected to the air-cooled system or a liquid-cooled system through the first three-way valve.

Further, the intermediate system comprises a first solenoid valve, a compressor and a one-way check valve sequentially provided along the flow path of the gaseous refrigerant outputted from the cold plate heat exchanger tube; a first temperature sensor for detecting the temperature of the gaseous refrigerant is provided on the section of pipeline between the outlet side of each cold plate heat exchange tube and the first solenoid valve; an outdoor temperature sensor for detecting the outdoor temperature is provided on the section of the pipeline between the one-way check valve and a first three-way valve.

Further, the outlet of the liquid storage tank is connected to the battery management system line via a throttling element; a second temperature sensor for detecting the temperature of the liquid refrigerant is provided on the section of the line between the throttling element and the battery management system.

Further, the air-cooling system comprises a condenser and a condensing fan, the heat exchanger tube of the condenser is connected via a pipeline between an output port of the first three-way valve and an input port of the second three-way valve; the output port of the second three-way valve is connected via a pipeline to an inlet port of a liquid storage tank; the control system is also used to adjust the speed of the condensing fan according to the relationship between the actual compression ratio of the compressor and the minimum compression ratio, the maximum compression ratio, and the preset compression ratio.

Further, the liquid cooling system comprises a shell and tube heat exchanger and the thermostatic water tank, a shell and tube refrigerant tube is provided in the middle of the cavity of the shell and tube heat exchanger, and the shell and tube refrigerant tube is surrounded by a phase-change energy storage unit; and an cavity outlet of the shell and tube heat exchanger is connected to the inlet piping of the thermostatic water tank through a second solenoid valve; the outlet of the constant temperature water tank is connected in line between the circulating water pump, the circulating water ball valve, the inlet solenoid valve of the shell and tube heat exchanger and the inlet of the cavity of the shell and tube heat exchanger in turn; the ends of the shell and tube refrigerant tubes are connected between the other output port of the first three-way valve and the other input port of the second three-way valve.

An aspect of the present disclosure is summarized as a method of controlling a dual cooling source direct-expansion liquid cooling system for battery energy storage comprises the following mode:

Air-cooling mode: When the outdoor temperature is detected to be less than or equal to 20° C., the air-cooling system will be turned on, and the heat from the battery pack will transfer to the cold plate, so that the phase-change thermostatic material inside the cold plate will be heated and changed from solid phase to liquid phase. At the same time, the refrigerant entering the cold plate heat exchanger tube exchanges heat with the phase change constant temperature material, and is converted from liquid refrigerant to gaseous refrigerant. The gaseous refrigerant enters the air cooling system and is cooled to liquid refrigerant, and then flows back to the cold plate to evaporate under heat, forming a cycle.

Liquid cooling mode 1: when the outdoor temperature is detected to be greater than 20° C., while the temperature of the gaseous refrigerant output from the cold plate is less than or equal to 25° C., turn on the liquid cooling system, and adjust the temperature of the thermostatic water tank to the first target temperature, and then transport the circulating water of the thermostatic water tank to the tubular heat exchanger, and then store the circulating water's heat through the process of phase change by the phase-change energy storage unit in the tubular heat exchanger. At the same time, the refrigerant entering the cold plate heat exchange pipe exchanges heat with the phase change thermostatic material, and is converted from liquid refrigerant to gaseous refrigerant. The gaseous refrigerant enters the shell and tube refrigerant tube of the shell and tube heat exchanger and changes phase to liquid refrigerant, and then flows back to the cold plate to be heated and evaporated, forming a cycle.

Liquid cooling mode 2: when the outdoor temperature is greater than 20° C., and the temperature of the gaseous refrigerant output from the cold plate is greater than 25° C., turn on the liquid cooling system, and adjust the temper of the thermostatic water tank to the second target temperature, and the second target temperature is lower than the first target temperature. Afterwards, the circulating water from the thermostatic tank is transported to the shell and tube heat exchanger, where the heat of the circulating water is stored by a phase change process in a phase change energy storage unit within the shell and tube heat exchanger. At the same time, the refrigerant entering the cold plate heat exchange pipe exchanges heat with the phase change thermostatic material, and is converted from liquid refrigerant to gaseous refrigerant. The gaseous refrigerant enters the shell and tube refrigerant tube of the shell and tube heat exchanger and changes phase to liquid refrigerant, and then flows back to the cold plate to be heated and evaporated, forming a cycle.

Further, the refrigerant entering the cold plate heat exchange tube exchanges heat with the phase change thermostatic material, and is converted from a liquid refrigerant to a high-temperature, low-pressure gaseous refrigerant, and the high-temperature, low-pressure gaseous refrigerant enters the compressor through the solenoid valve, under the action of the compressor into a high temperature and high pressure gaseous refrigerant, and then through the check valve into the liquid cooling system or air-cooled system condensed into a low-temperature and high-pressure liquid refrigerant, low-temperature and high-pressure liquid refrigerant flows into the liquid storage tank, in the throttling element of the throttle function into a low-temperature and low-pressure liquid refrigerant, and then through the first control valve into the corresponding cold plate to achieve the effect of cyclic refrigeration.

Further, the air cooling system includes a condenser and a condensing fan, condensing fan having a rotational speed adjusted according to the relationship between the actual compression ratio of the compressor ε=P₁/P₂ and the minimum compression ratio εₘᵢₙ, the maximum compression ratio εₘₐₓ, and the preset compression ratio ε₁, where P₁ is the outlet pressure of the compressor; P₂ is the inlet pressure of the compressor; The condensing fan speed is adjusted as follows:
When ε≤εₘᵢₙ, the condensing fan is turned off;
When εₘᵢₙ<ε₁<εₘₐₓ, the speed of the condensing fan decreases;
When εₘᵢₙ<E₁<ε<εₘₐₓ, the speed of the condensing fan increases;
When εₘᵢₙ<E₁=ε<εₘₐₓ, the speed of the condensing fan is kept constant;
When ε≥εₘₐₓ, the condensing fan speed is adjusted to 100%.

Further, the valve opening of the throttling element is adjusted according to the relationship between the compressor low pressure value P₂ and the low pressure alarm value Pₘᵢₙ:
When P₂≤Pₘᵢₙ, the opening of the throttling element increases;
When P₂>Pₘᵢₙ, the throttle element opening remains constant.

### Beneficial Effects of the Present Disclosure

1. By filling the cold plate with phase-change thermostatic material to cool down the battery directly, and by combining the air-conditioning refrigeration system and battery management system to evaporate the refrigerant and then cool down the phase-change thermostatic material to avoid the condensation problem brought about by the direct use of the refrigerant and the outdoor condenser frost in winter, to ensure the safe and stable operation of the battery;
2. By combining the phase change thermostatic material in the cold plate with the phase change energy storage unit in the shell and tube heat exchanger, and through the phase change energy storage process, it makes full use of the natural cold source to realize nighttime charging and daytime discharging, which further reduces the energy consumption of the cooling system;
3. By combining multiple temperature sensors, it can flexibly control the two three-way valves to switch the cooling mode according to the temperature to ensure the reliable operation of the cooling system and realize the energy saving and consumption reduction of the cooling system;
4. Direct-expansion liquid-cooling system architecture is simple, easy to install and maintain;
5. By adjusting the speed of the condensing fan and the opening of the throttling element through the compressor pressure in order to realize the precise regulation of the compression ratio, so as to avoid the compressor from entering the non-normal operating range, increase the reliability of the compressor and reduce the problem of the system not being able to operate under low-temperature working conditions;
6. By designing the parameter relationship between the phase-change thermostatic material and the battery pack, it can ensure that the phase-change thermostatic material meets the heat dissipation requirements of the battery pack; and by designing the parameter relationship between the phase-change thermostatic material and the refrigerant in the cold plate heat exchanger tube, it can ensure that the refrigerant in the cold plate heat exchanger tube meets the heat dissipation requirements of the phase-change thermostatic material;
7. By designing the parameter relationship between the phase change energy storage unit and the battery pack, emergency cooling can be realized when the circulating water is interrupted to ensure the reliable operation of the cooling system; at the same time, the phase change energy storage unit can make full use of the natural cold source to realize charging at nighttime and discharging during the daytime to reduce the energy consumption of the cooling system operation.

### BRIEF DESCRIPTION OF THE DRAWINGS

FIG. 1 shows the general operating schematic;

FIG. 2 shows the operating schematic in air-cooled mode;

FIG. 3 shows the operating schematic in liquid cooling mode;

FIG. 4 shows a schematic diagram of the structure of the cold plate;

FIG. 5 shows a schematic diagram of the exterior structure of the shell and tube heat exchanger;

FIG. 6 shows a perspective view of the shell and tube heat exchanger shown in FIG. 5.

### LEGEND IDENTIFICATION DESCRIPTION

1. Condenser; 2. Liquid storage tanks; 3. Electronic expansion valve; 4. Ball valve; 5. Cold plate; 6. Battery pack; 7. Solenoid valve; 8. Compressor; 9. Check valve; 10. Condensing fan; 11. Refrigerant charge/drain port; 12. Temperature sensor A; 13. Temperature sensor B; 14. Exhaust ball valve; 15. Automatic exhaust valve; 16. Refrigerant fluid tube; 17. Refrigerant gas line; 18. Phase change thermostatic materials; 19. Battery temperature sensor; 20. Three-way valve A; 21. Three-way valve B; 22. Shell and tube heat exchangers; 23. Thermostatic water tanks; 24. Circulating water pumps; 25. Thermostatic water tank fill valve; 26. Circulating water ball valve; 27. Shell and tube heat exchanger outlet solenoid valve; 28, shell and tube heat exchanger inlet solenoid valve; 29. Phase change energy storage units; 30. Shell and tube refrigerant tubes; 31. Circulating water inlet piping; 32. Circulating water outlet piping; 33. Outdoor temperature sensor.

### DETAILED DESCRIPTION

The disclosure will be described in further detail hereinafter in connection with the accompanying drawings of the specification and specific embodiments.

### Case 1

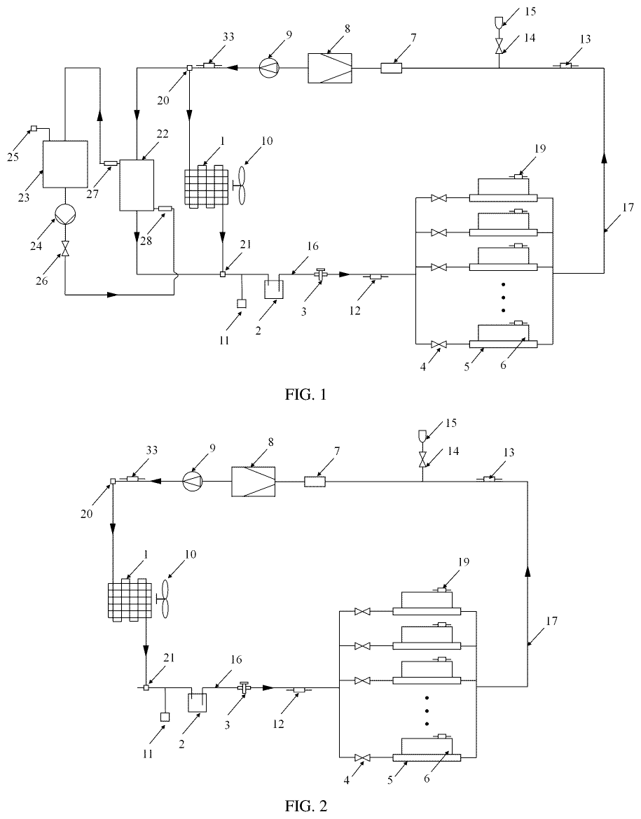

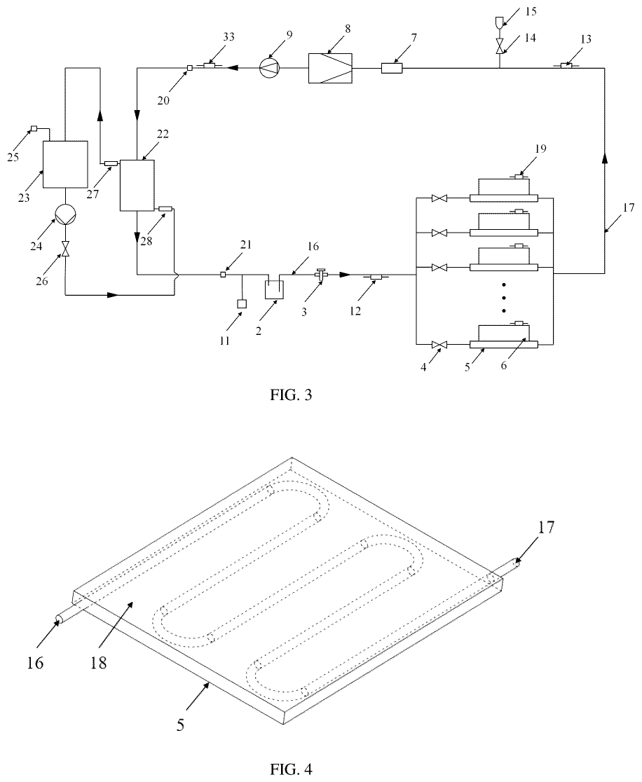

As shown in FIG. 1-FIG. 3, a dual cooling source direct-expansion liquid cooling system for battery energy storage includes an air conditioning and refrigeration system, a battery management system, and a control system. The air conditioning and refrigeration system includes an air-cooling system and a liquid-cooling system, and the air-cooling system and the liquid-cooling system are switched and controlled by a three-way valve A20 and a three-way valve B21.

In this case, the air cooling system includes a condenser 1 and a condensing fan 10; the liquid cooling system includes a shell and tube heat exchanger 22, a thermostatic water tank 23, and a circulating water pump 24; the air-cooled system and the liquid-cooled system share the same liquid storage tank 2, electronic expansion valve 3, solenoid valve 7, compressor 8, check valve 9, refrigerant charge/discharge port 11, exhaust ball valve 14 and automatic exhaust valve 15; the battery management system includes a ball valve 4, a cold plate 5, a battery pack 6, a refrigerant fluid line 16, a refrigerant gas line 17, and a phase change thermostatic material 18.

Specifically, the output end of the battery management system is piped to the solenoid valve 7, the compressor 8, and the check valve 9 in sequence through plpelines along the flow path of the gaseous Freon; the output of the check valve 9 is divided into two branches by the three-way valve A20, one branch is connected to the input end of the liquid cooling system, and the other branch is connected to the input end of the air cooling system. The output ends of the air-cooling system and the liquid-cooling system are respectively connected to the two inputs of the three-way valve B21, and the output of the three-way valve B21 is connected to the inlet pipeline of the liquid storage tank, and the outlet pipeline of the liquid storage tank is connected to the input pipeline of the battery management system through the electronic expansion valve 3.

Further specifically, in the battery management system, a plurality of battery packs 6 are provided in parallel and a cold plate 5 is provided at the bottom of each of the battery packs 6, and the battery packs are able to directly contact the cold plate 5 for heat exchange. Each cold plate 5 is connected in series with a ball valve 4; each ball valve is connected in parallel with each other, and the inlet end of each ball valve serves as the input end of the battery management system. Each cold plate 5 is connected in parallel with each other, and the outlet end of each cold plate serves as the output end of the battery management system. In addition, each battery pack 6 is provided with a battery temperature sensor 19 for detecting the temperature of the battery in real time.

As shown in FIG. 4: In this case, the cold plate 5 is provided with a phase change thermostatic material 18 and a heat exchanger tube; the heat exchanger tube is a U-shaped tubular heat exchanger tube to run through the cold plate, and the input end of the heat exchanger tube is connected to a refrigerant liquid tube 16; the liquid storage tank 2 is connected to the heat exchanger tube of the cold plate 5 via the refrigerant liquid tube 16, the electronic expansion valve 3 and the ball valve 4 are connected to the refrigerant liquid tube 16, and there is also provided on the section of the refrigerant liquid tube 16 located at the rear side of the electronic expansion valve a detection temperature sensor A12 for the temperature of the liquid Freon in the refrigerant liquid tube. The output end of the heat exchanger tube is connected to a refrigerant gas tube 17, which is connected to the solenoid valve 7 via the refrigerant gas tube 17, and the refrigerant gas tube 17 is provided with a temperature sensor B13 for detecting the temperature of gaseous Freon in the refrigerant gas tube 17; an exhaust ball valve 14 and an automatic exhaust valve 15 are also provided in series connection on the section of the refrigerant gas line 17 located between the temperature sensor B13 and the solenoid valve 7 for discharging exhaust gas from the refrigerant gas line 17.

In this case, the phase change thermostatic material 18 is filled with a volume of V₁, density ρ₁, latent heat of phase transition Q₁, the total heat of battery pack 6 is [symbol] (1600 W˜1700 W at 1 C charging/discharging rate, 450 W˜500 W at 0.5 C charging/discharging rate), the time t is determined by the charge/discharge multiplier (3600 s at 1 C charging/discharging rate, 7200 s at 0.5 C charging/discharging rate). Satisfies the following relational equation: V₁ρ₁Q₁= [symbol] , this parameter setting ensures that the phase change thermostatic material 18 is capable of meeting the heat dissipation needs of the battery pack 6.

In this case, the phase change thermostatic material 18 is filled with a volume of V₁ (range of values 0.015 m³˜0.045 m³), density ρ₁ (range of values 860 kg/m³˜930 kg/m³); the volume of refrigerant in the cold plate heat exchanger tube is V₂ (range of values 0.010 m³˜0.030 m³), density ρ₂ (range of values 1200 kg/m³˜1500 kg/m³). The exact value of V₁, V₂ is based on the latent heat Q₁ of phase change of the phase change thermostatic material 18 (range of values 160 kJ/kg˜270 kJ/kg) and latent heat of vaporization of refrigerant Q₂ (range of values 150 kJ/kg˜200 kJ/kg). Satisfies the following relational equation: V₁ρ₁Q₁=V₂ρ₂Q₂. this parameter setting ensures that the refrigerant in the cold plate heat exchanger tube meets the heat dissipation requirements of the phase change thermostat material 18.

In this case, the type of phase change thermostatic material 18 could be an inorganic phase change thermostatic material or an organic phase change material. The refrigerant passed in the refrigerant fluid tube 16 may be one of Freon R22, R32, R134a, R410a.

In this case, the liquid storage tanks 2 is provided with a refrigerant charge/drain port 11 on the inlet piping.

In this case, the air conditioning and the battery management system are connected in series with each other through the gas-liquid phase change of the refrigerant Freon in order to realize the heat transfer. The battery pack 6 is in direct contact with the cold plate 5 for heat exchange, phase change thermostatic material 18 is provided in the cavity of the cold plate 5, the cold plate 5 transfers heat to the phase change thermostatic material 18 to absorb heat through a phase change process, which in turn exchanges heat with the heat exchanger tube of the cold plate, that is, after the liquid Freon stored in the liquid storage tank 2 enters the heat exchanger tube of the cold plate 5 through the refrigerant liquid tube 16, the heat absorbed by the phase change thermostatic material 18 phase changes through the liquid Freon in the refrigerant liquid tube 16 to the gaseous Freon in the refrigerant gas tube 17, the high-temperature, low-pressure gaseous Freon in the refrigerant gas line 17 enters the compressor 8 through the solenoid valve 7. Under the action of compressor 8, it turns into high temperature and high pressure gaseous Freon, and then through the check valve 9 into the air conditioning refrigeration system condensed into low temperature and high pressure liquid Freon, low temperature and high pressure liquid Freon into the liquid storage tank 2, in the electronic expansion valve 3 under the effect of throttling into low temperature and low pressure liquid Freon, and again through the ball valve 4 into the corresponding cold plate 5 to achieve the effect of circulating refrigeration. The refrigerant circulation process as cooling phase change thermostatic material 18 is, in order, cold plate 5, solenoid valve 7, compressor 8, check valve 9, air conditioning and refrigeration system, liquid storage tank 2, electronic expansion valve 3, ball valve 4, cold plate 5.

In this case, the heat exchanger tube of the condenser 1 of the air-cooled system is piped between an output port of the three-way valve A20 and an input port of the three-way valve B21; the high-temperature, high-pressure gaseous Freon entering the condenser heat exchanger tube exchanges heat with the condensing fan 10 and becomes low-temperature, high-pressure liquid Freon flowing into the liquid storage tank 2. By setting the liquid storage tank 2, it makes sense to adjust the suction volume of the compressor, effectively suppressing system pressure fluctuations and reducing the risk of system downtime.

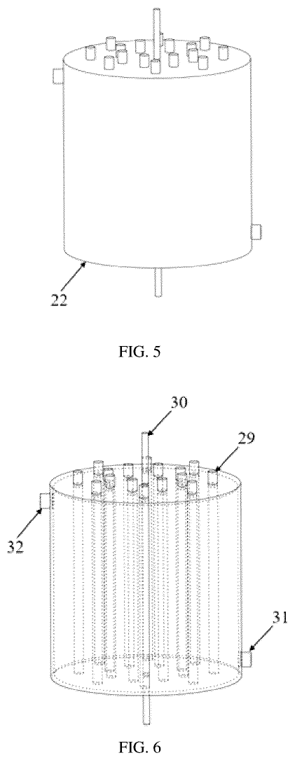

As shown in FIGS. 5 and 6: In this embodiment, the shell and tube heat exchanger 22 of the liquid cooling system is a cylindrical structure, and a shell and tube refrigerant tube 30 is provided in the middle of the shell and tube heat exchanger 22. The shell and tube refrigerant tube 30 is surrounded by a phase change energy storage unit 29, the phase change energy storage unit 29 is provided with a plurality of tubes from inside to outside along the the shell and refrigerant tube 30, the tubes are filled with a phase change thermostatic material 18, and the type of phase change material may be an inorganic phase change thermostatic material or an organic phase change material. The outlet of the cylinder is connected to the solenoid valve 27 and the inlet of the thermostatic water tank 23 in turn via the circulating water outlet pipe 32; the outlet of the thermostatic water tank 23 is connected in turn through the circulating water pump 24, the circulating water ball valve 26, the shell and tube heat exchanger inlet solenoid valve 28 and the inlet of the shell and tube heat exchanger 22 via the circulating water inlet pipe 31; the ends of the shell refrigerant tube 30 are connected between another output port of the three-way valve A20 and another input port of the three-way valve B21; the low temperature circulating water in the constant temperature water tank 23 enters the barrel of the shell and tube heat exchanger 22 via the circulating water pump 24, and the heat of the circulating water is stored by the phase change storage unit 29 through a phase change process, and the heat stored in the phase change storage unit 2 phase changes the high temperature and high pressure gaseous Freon in the shell and tube refrigerant tubes 30 to the low temperature and high pressure liquid Freon flowing into the liquid storage tank 2. In addition, the thermostatic water tank 23 is provided with a thermostatic water tank fill valve 25.

In this case, the diameter of the tube of the phase change energy storage unit 29 Dₛ (range of values≥9.3 mm) is larger than the diameter of the tube of the shell refrigerant tube 30 D (range of values 6 mm to 9 mm), there are 8 tubes in each of the inner and outer layers around the shell refrigerant tube 30, for a total of 16 tubes. The length of the tube body of the phase change energy storage unit 29 lₛ (take the value of 330 mm), and the parameter of the tube diameter of the phase change energy storage unit 29 Dₛ determined by the total heat [symbol] of the battery pack 6, satisfies the following relational equation: 4πDₛ²lₛρ₁Q₁εn [symbol] , where n is the number of battery packs 6 in parallel (usually n=8). This setting enables emergency cooling in case of circulating water interruption and ensures reliable operation of the cooling system; at the same time, the phase change energy storage unit 29 can make full use of the natural cold source to realize charging at nighttime and discharging during the daytime, reducing the energy consumption of the cooling system operation.

In this case, the control system is used when the outdoor temperature is detected to be no greater than the set temperature, the three-way valve A20 and the three-way valve B21 are controlled to switch to an air-cooled system, and the three-way valve A20 and the three-way valve B21 are controlled to switch to a liquid-cooled system when the constant outdoor temperature is detected to be greater than the set temperature; it is also used to control the thermostatic water tank of the liquid cooling system to adjust the temperature to the first target temperature when the outdoor temperature is detected to be greater than the set temperature and the temperature of the gaseous refrigerant output from the cold plate is not greater than the set temperature of the gaseous refrigerant; and control the thermostatic water tank of the liquid cooling system to thermoregulate to the second target temperature when the outdoor temperature is detected to be greater than the set temperature and the temperature of the gaseous refrigerant output from the cold plate is greater than the set temperature of the gaseous refrigerant, and the second target temperature is lower than the first target temperature.

In this case, an outdoor temperature sensor 33 for real-time monitoring of the outdoor air temperature is provided in the section of piping between the output of the check valve 9 and the three-way valve A20. This case changes the direction of the three-way valve A20 and the three-way valve B21 to switch to the air-cooling mode based on the measurements of the outdoor temperature sensor 33 and the temperature sensor B13.

Air-cooled mode: When the outdoor temperature is detected to be less than or equal to 20° C., the condensing fan 10 is turned on, and the heat transferred from the battery pack 6 to the cold plate 5 causes the phase-change thermostatic material 18 inside the cold plate 5 to be heated to change from a solid phase to a liquid phase. At the same time, the Freon in the refrigerant liquid pipe 16 is heated from the liquid phase to the gaseous phase, i.e., it is converted into high temperature and low-pressure gaseous Freon, which is sent to the compressor 8 through the refrigerant gas tube 17; under the action of compressor 8, it turns into high-temperature and high-pressure gaseous Freon, and then enters condenser 1 through the one-way valve 9 and condenses into low-temperature and high-pressure liquid Freon, which flows into liquid tank 2, and then be converted into low-temperature and low-pressure liquid refrigerant under the throttling action of electronic expansion valve 3, and then flows back to the cold plate 5 through the ball valve 4 to be evaporated by heat and form a cycle.

In this case, the liquid cooling mode is switched to the liquid cooling mode by changing the direction of the three-way valve A20 and the three-way valve B21 according to the measured values of the outdoor temperature sensor 33 and the temperature sensor B13. The liquid cooling mode is divided into the following two working conditions.

Liquid-cooled condition 1: When the outdoor temperature is detected to be greater than 20° C. and the refrigerant gas tube temperature is less than or equal to 25° C., the thermostatic water tank 23 adjusts the temperature to 20° C., the shell and tube heat exchanger inlet solenoid valve 28 opens, the shell and tube heat exchanger outlet solenoid valve 27 opens, and the circulating water pump 24 opens. When the temperature of the shell and tube heat exchanger 22 reaches 20° C., the shell and tube heat exchanger inlet solenoid valve 28 is closed, the shell and tube heat exchanger outlet solenoid valve 27 is closed, and the circulating water pump 24 is closed. At this time, the cold source is provided by the phase change energy storage unit 29 inside the shell and tube heat exchanger 22.

Liquid-cooled condition 2: When the outdoor temperature is greater than 20° C. and the refrigerant gas tube temperature is greater than 25° C., the thermostatic water tank 23 adjusts the temperature to 18° C., the shell and tube heat exchanger inlet solenoid valve 28 is opened, the shell and tube heat exchanger outlet solenoid valve 27 is opened, and the circulating water pump 24 is opened. The gaseous Freon in the refrigerant gas tube 17 is changed into a liquid state by heat exchange with the heat of the 18° C. circulating water stored in the phase change energy storage unit 29, and then flows back to the cold plate 5 through the refrigerant liquid tube 16 to be heated and evaporated, forming a cycle.

In this case, by setting two liquid cooling conditions and combining the phase-change thermostatic material 18 inside the cold plate 5 with the phase-change energy storage unit 29 inside the shell-and-tube heat exchanger 22, it is possible to make full use of the natural cold source to realize nighttime charging, and daytime discharging.

In summary, this case, on the one hand, the use of flexible control according to the temperature to switch the mode of cooling, can ensure the reliable operation of the cooling system, realize the cooling system of energy saving and consumption reduction. At the same time, the cold plate is filled with phase-change thermostatic material to cool down the battery directly, and then cool down the phase-change thermostatic material through the evaporation of the refrigerant, which avoids the problem of condensate brought about by the direct use of the refrigerant and the problem of outdoor condenser frost in winter; on the other hand, the phase change thermostatic material in the cold plate and the phase change energy storage unit in the shell and tube heat exchanger make full use of the natural cold source to realize nighttime charging and daytime cooling, which further reduces the energy consumption of the cooling system through the phase change energy storage process. Moreover, the direct-expansion liquid-cooling system has a simple structure and is easy to install and maintain.

### Case 2

On the basis of Case 1, the inlet side of the compressor 8 is provided with a first pressure sensor for detecting the inlet pressure of the compressor, the outlet side of the compressor 8 is provided with a second pressure sensor for detecting the outlet pressure of the compressor, the first pressure sensor acquires the low pressure value P₂ of the compressor, and the second pressure sensor acquires the high pressure value P₁ of the compressor. The control system is used to adjust the rotational speed of the condensing fan 10 according to the relationship between the actual compression ratio of the compressor 8 and the minimum compression ratio, the maximum compression ratio, and the preset compression ratio; and it is also used to adjust the opening degree of the electronic expansion valve 3 according to the relationship between the compressor low-pressure value P₂ and the low-pressure alarm value Pₘᵢₙ.

Specifically, the rotational speed of the condensing fan 10 is adjusted according to the relationship between the actual compression ratio of the compressor ε=P₁/P₂ and the minimum compression ratio εₘᵢₙ, the maximum compression ratio εₘₐₓ, and the preset compression ratio ε₁.

The speed of the condensing fan 10 is adjusted in a manner:
1) When ε≤εₘᵢₙ, the condensing fan 10 is turned off;
2) When εₘᵢₙ<ε₁<εmax, the rotation speed of the condensing fan 10 decreases;
3) When εₘᵢₙ<ε₁<ε<εₘₐₓ, the rotational speed of the condensing fan 10 increases;
4) When εₘᵢₙ<ε₁=ε<εₘₐₓ, the rotation speed of the condensing fan 10 remains constant;
5) When ε≥εₘₐₓ, the speed of the condensing fan 10 is adjusted to 100%.

In this case, the opening of the electronic expansion valve 3 is adjusted according to the relationship between the compressor low-pressure value P₂ and the low-pressure alarm value Pₘᵢₙ.

The opening adjustment mode of the electronic expansion valve 3 is:
1) When P₂≤Pₘᵢₙ, the opening of the electronic expansion valve 3 increases;
2) When P₂>Pₘᵢₙ, the opening of the electronic expansion valve 3 remains constant.

In this case, the compressor pressure is used to adjust the rotational speed of the condensing fan 10 and the opening of the electronic expansion valve 3 in order to realize the precise regulation of the compression ratio, so as to avoid the compressor from entering the non-normal operation zone, increase the reliability of the compressor, and reduce the problem of the system not being able to operate under low-temperature working conditions.

The above shows and describes the basic principles, main features and advantages of the present inventive creation. It should be understood that the description of these embodiments is merely intended to enable those skilled in the art to better understand and to further practice the present disclosure, and is not intended to limit the scope of the present disclosure in any way and that the above embodiments and the description in the specification are only illustrative of the principles of the present inventive creation, and that there will be various changes and improvements to the present inventive creation without departing from the spirit and scope of the present inventive creation, and that these changes and alterations fall within the scope of the present inventive creation for which protection is claimed.

1. A dual cooling source direct expansion liquid cooling system for battery energy storage, comprising:
an air conditioning and refrigeration system, comprises an air-cooling system and a liquid-cooling system;
the air-cooling system and the liquid-cooling system are controlled by switching a first three-way valve and a second three-way valve;
a battery management system, comprises a plurality of battery packs and a cold plate provided opposite the battery packs;
the battery packs are in direct contact with the cold plate for heat exchange;
the cold plate is provided with a heat exchanger tube running through the cold plate and a phase change thermostatic material;
the phase change thermostatic material is used to absorb heat from the battery pack and change the liquid refrigerant phase into gaseous refrigerant entering the heat exchanger tube;
the heat exchanger tube output of the cold plate is connected to the air conditioning and refrigeration system via an intermediate system;
a control system, for controlling the first three-way valve and the second three-way valve to switch to an air-cooling system when the outdoor temperature is detected to be not greater than a set temperature,
and for controlling the first three-way valve and the second three-way valve to switch to a liquid-cooling system when the outdoor temperature is detected to be greater than the set temperature;
further for controlling the constant temperature water tank of the liquid cooling system to adjust the temperature to a first target temperature when the outdoor temperature is detected to be greater than the set temperature and the temperature of the gaseous refrigerant output from the cold plate is not greater than the set temperature of the gaseous refrigerant; and controlling the thermostatic water tank of the liquid cooling system to thermoregulate to a second target temperature when the outdoor temperature is detected to be greater than the set temperature and the temperature of the gaseous refrigerant output from the cold plate is greater than the set temperature of the gaseous refrigerant, and the second target temperature is lower than the first target temperature.

2. A dual cooling source direct-expansion liquid cooling system for battery energy storage of claim 1, the plurality of battery packs are set up in parallel with each other, the cold plate is provided at the bottom of each battery pack, and a first control valve is connected in series with the inlet side of the heat exchanger tube of each cold plate;
the inlet side of each of the first control valves is jointly connected to the liquid outlet of the liquid storage tank through a pipeline, and the liquid inlet of the liquid storage tank is connected to the air conditioning and refrigeration system;
the outlet side of the heat exchanger tubes of each cold plate are jointly connected to said intermediate system via a pipeline;
the output of the intermediate system is selectively connected to an air-cooled system or a liquid-cooled system through a first three-way valve.

3. A dual cooling source direct-expansion liquid cooling system for battery energy storage of claim 1, the intermediate system comprises a first solenoid valve, a compressor, and a check valve disposed in sequence along the gaseous refrigerant flow path output from the cold plate heat exchanger tube;
a first temperature sensor for detecting the temperature of the gaseous refrigerant is provided in the section of pipe between the outlet side of each cold plate heat exchanger tube and the first solenoid valve;
an outdoor temperature sensor for detecting the outdoor temperature is provided in the section of piping between said check valve and the first three-way valve.

4. A dual cooling source direct-expansion liquid cooling system for battery energy storage of claim 2, the outlet of the liquid storage tank is connected to the battery management system line via a throttling element;
a second temperature sensor for detecting the temperature of the liquid refrigerant is provided in the section of piping between said throttling element and the battery management system.

5. A dual cooling source direct-expansion liquid cooling system for battery energy storage of claim 3, the air-cooling system comprises a condenser and a condensing fan, and a heat exchanger tube of the condenser is connected between an output port of a first three-way valve and an input port of a second three-way valve;
the output port of the second three-way valve is piped to the inlet port of the liquid storage tank;
the control system is also used to adjust the speed of the condensing fan based on the relationship between the actual compression ratio of the compressor and the minimum compression ratio, the maximum compression ratio, and the preset compression ratio.

6. A dual cooling source direct-expansion liquid cooling system for battery energy storage of claim 3, wherein the liquid cooling system comprising a shell and tube heat exchanger and said thermostatic water tank, the shell and tube heat exchanger having a shell and tube refrigerant tube in the middle of the cavity, the shell and tube refrigerant tube surrounded by a phase change energy storage unit;
the chamber outlet of the shell and tube heat exchanger is connected to the inlet line of the thermostatic water tank via a second solenoid valve;
the outlet of the constant temperature water tank in turn through the circulating water pump, circulating water ball valve, shell and tube heat exchanger inlet solenoid valve and shell and tube heat exchanger chamber between the inlet piping connection;
the ends of the shell refrigerant tube are connected between another output port of the first three-way valve and another input port of the second three-way valve.

7. A control method of a dual cooling source direct-expansion liquid cooling system for battery energy storage, the method comprises the following three modes:
air-cooling mode: when the outdoor temperature is detected to be less than or equal to 20° C., the air-cooling system will be turned on, and the heat from the battery pack will be transferred to the cold plate, so that the phase-change thermostatic material inside the cold plate will be heated and change from solid phase to liquid phase;
at the same time, the refrigerant entering the cold plate heat exchanger tube exchanges heat with the phase change constant temperature material, and is converted from liquid refrigerant to gaseous refrigerant;
the gaseous refrigerant enters the air cooling system and is cooled to liquid refrigerant, and then flow back to the cold plate by the heat of the evaporation, the formation of the cycle;
liquid cooling mode 1: when the outdoor temperature is detected to be greater than 20° C., and the temperature of the gaseous refrigerant output from the cold plate is less than or equal to 25° C., turn on the liquid cooling system, and adjust the temperature of the thermostatic water tank to the first target temperature, and then transport the circulating water of the thermostatic water tank to the tubular heat exchanger, and then store the circulating water's heat through the process of phase change by the phase-change energy storage unit in the tubular heat exchanger;
at the same time, the refrigerant entering the cold plate heat exchanger tube exchanges heat with the phase change constant temperature material, and is converted from liquid refrigerant to gaseous refrigerant;
the gaseous refrigerant enters the air cooling system and is cooled to liquid refrigerant, and then flow back to the cold plate heat evaporation, the formation of the cycle;
liquid cooling mode 2: when the outdoor temperature is greater than 20° C., and the temperature of the gaseous refrigerant output from the cold plate is greater than 25° C., turn on the liquid cooling system, and temper the thermostatic water tank to the second target temperature, and the second target temperature is lower than the first target temperature;
afterwards, the circulating water from the thermostatic tank is transported to the shell and tube heat exchanger, where the heat of the circulating water is stored by a phase change process in a phase change energy storage unit within the shell and tube heat exchanger. At the same time, the refrigerant entering the cold plate heat exchanger tube exchanges heat with the phase change constant temperature material, and is converted from liquid refrigerant to gaseous refrigerant;
the gaseous refrigerant enters the air cooling system and is cooled to liquid refrigerant, and then flow back to the cold plate by the heat of the evaporation, the formation of cycle.

8. Method of controlling a dual cooling source direct-expansion liquid cooling system for battery energy storage of claim 7, the refrigerant entering the cold plate heat exchanger tube exchanges heat with the phase-change constant temperature material and is converted from liquid refrigerant to high-temperature, low-pressure gaseous refrigerant; the high-temperature, low-pressure gaseous refrigerant enters the compressor through the solenoid valve and becomes high-temperature, high-pressure gaseous refrigerant under the action of the compressor;
the refrigerant then enters the liquid cooling system or the air cooling system through the one-way valve and is condensed into low-temperature, high-pressure liquid refrigerant; the low-temperature, high-pressure liquid refrigerant flows into the liquid storage tank and becomes low-temperature, low-pressure liquid refrigerant under the throttling action of the throttling element;
the refrigerant then enters the corresponding cold plate through the first control valve again to achieve a circulating refrigeration effect.

9. Method of controlling a dual cooling source direct-expansion liquid cooling system for battery energy storage of claim 8, the air cooling system comprises a condenser and a condensing fan, the condensing fan having a rotational speed adjusted according to the relationship between the actual compression ratio of the compressor ε=P₁/P₂ and the minimum compression ratio εₘᵢₙ, the maximum compression ratio εₘₐₓ, and the preset compression ratio ε₁, where P₁ is the outlet pressure of the compressor;
P₂ is the inlet pressure of the compressor;
the condensing fan speed is adjusted as follows:
When ε≤εₘᵢₙ, the condensing fan is turned off;
When εₘᵢₙ<ε₁<εₘₐₓ, the speed of the condensing fan decreases;
When εₘᵢₙ<ε₁<ε<εₘₐₓ, the speed of the condensing fan increases;
When εₘᵢₙ<ε₁=ε<εₘₐₓ, the speed of the condensing fan is kept constant;
When ε≥εₘₐₓ, the condensing fan speed is adjusted to 100%.

10. Method of controlling a dual cooling source direct-expansion liquid cooling system for battery energy storage of claim 9,
the valve opening of the throttling element is adjusted according to the relationship between the compressor low pressure value P₂ and the low pressure alarm value Pₘᵢₙ:
when P₂≤Pₘᵢₙ, the opening of the throttling element increases;
when P₂>Pₘᵢₙ, the throttle element opening remains constant.
